(19) United States
(12) Patent Application Publication
(10) Pub. No.: US 2026/0101313 A1
(43) Pub. Date: Apr. 9, 2026

(54) COMMUNICATION METHOD AND RELATED DEVICE

(71) Applicant: HUAWEI TECHNOLOGIES CO., LTD., Shenzhen (CN)

(72) Inventors: Rojan Chitrakar, Singapore (SG); Lei Huang, Singapore (SG); Yunbo Li, Shenzhen (CN); Xun Yang, Singapore (SG)

(73) Assignee: HUAWEI TECHNOLOGIES CO., LTD., Shenzhen (CN)

(21) Appl. No.: 19/417,935

(22) Filed: Dec. 12, 2025

Related U.S. Application Data
(63) Continuation of application No. PCT/CN2023/100512, filed on Jun. 15, 2023.

(51) Int. Cl. H04W 64/00; H04B 1/7163

(52) U.S. Cl. CPC H04W 64/00; H04B 1/7163

(57) ABSTRACT

The present application describes a communication method and related device. The method includes a first responder receiving from an initiator a first frame for initiating a ranging process. The first responder generates a first private address based on the first frame and information related to an identity of the first responder, and the first responder transmits a second frame carrying the first private address to the initiator. The method may be applied to ultra-wideband multi-millisecond ranging systems. According to this application, an initiator can verify whether a frame is really from an authorized responder in an ultra-wideband multi-millisecond ranging session.

### CROSS-REFERENCE TO RELATED APPLICATIONS

The present application is a continuation of International Application No. PCT/CN2023/100512, filed on Jun. 15, 2023, the disclosure of which is hereby incorporated by reference in its entirety.

### TECHNICAL FIELD

Embodiments of the present application relate to the field of communications technologies, and more specifically, to a communication method and related device.

### BACKGROUND

Ultra-wideband (UWB) technology is increasingly being used for indoor positioning and other location services such as access control and asset locating. To address the long-range ranging use case, UWB multi-millisecond (MMS) ranging has been introduced. The key idea behind MMS ranging is to distribute the UWB ranging frames into multiple fragments and the fragment being transmitted across multiple milliseconds (ms), thereby overcoming the emitted energy limit of 37 nanojoules (nJ) per ms. By distributing the ranging frame over several fragments, each fragment being transmitted in one millisecond, the total energy of the ranging frame can be several times higher, thereby considerably increasing the ranging range. This means that when the block-based mode is used for MMS ranging, the control frame transmission time would be limited to 1 ms, which also results in very limited available space for the actual control information in the control frame. In order to overcome this limitation, a compressed physical layer service data unit (PSDU) format that uses a private address has been introduced for the control frames.

In the MMS ranging session, when an initial compressed PSDU such as an advertisement poll (ADV-POLL) frame or a POLL frame, is to be transmitted, the initiator generates a pseudo random number RPA_prand and uses the random number RPA_prand to generate the private address RPA_hash. The responder verifies the identity of the initiator based on the RPA_prand and RPA_hash received from the initiator. If the responder intends to participate in a ranging session with the initiator, the responder transmits the response frame carrying the same RPA_hash.

In general, only the ADV-POLL frame and the POLL frame carry the RPA_hash and the RPA_prand while the rest of the frames only carry the RPA_hash from the preceding frame. That is to say, it is trivial for any device that receives the ADV-POLL frame or the POLL frame to copy the RPA_hash and transmit a response frame carrying the RPA_hash as its private address. In other words, the initiator cannot determine whether the response frame is truly from the authorized responder.

### SUMMARY

Embodiments of this application provide a communication method and related device, which allow an initiator in an MMS ranging session to verify that a frame is really from an authorized responder.

According to a first aspect, this application provides a communication method. The method is applied to a first responder, and the method includes:

receiving, from an initiator, a first frame for initiating a ranging process; generating a first private address based on the first frame and information related to an identity of the first responder; and transmitting a second frame carrying the first private address to the initiator.

For example, the information related to the identity of the first responder can uniquely identify the identity of the first responder. A frame for initiating a ranging process includes a frame for initiating the initialization and setup phase or a frame for initiating the measurement cycle phase.

The second frame may be a response frame of the first frame, or the second frame may be a frame transmitted after the response frame of the first frame. For example, the first frame is an ADV-POLL frame, and the second frame is an advertising response (ADV-RESP) frame. Alternatively, the first frame is a POLL frame, and the second frame is a response (RESP) frame. Alternatively, the first frame is a POLL frame, and the second frame is a report (RPRT) frame.

For example, the generating a first private address based on the first frame and information related to an identity of the first responder includes: verifying the identity of the initiator based on the first frame; and generating the first private address based on the information related to the identity of the first responder, when identity verification of the initiator succeeds.

It should be noted that the information related to the identity of the first responder is known to the initiator.

According to the above-mentioned technical solution, since the private address of a responder is generated based on the responder's identity, the initiator is enabled to identify whether the transmitter of the compressed frame is an authorized responder while maintaining the transmitter's privacy. Meanwhile, since there is no need to add new fields in the compressed frame, the size of the compressed frame can be minimized.

In an embodiment, the information related to the identity of the first responder includes any one of: a public address of the first responder, MMS ranging configuration requested by the first responder, a first random number generated by the first responder, or an identity resolving key (IRK) unique to the initiator and the first responder.

The public address of the first responder may include any one of an in band extended address and an out of band (OOB) public address.

It is essential for the responder to provide its public address during the session setup phase and/or carry the MMS ranging configuration in a compressed frame sent to the initiator in order to obtain the ranging results. Therefore, in the above-mentioned technical solution, the first responder uses the public address, or the MMS ranging configuration as the information related to its identity to generate a private address, eliminating the need for additional signaling exchange to notify the initiator of its identity information, which helps to reduce signaling overhead in ranging sessions. Besides, compared to static identity related information, random numbers can be frequently updated, thus taking the first random number as the information related to the identity of the first responder can help improve communication security. Taking the IRK that is unique between the initiator and the first responder as the information related to the identity of the first responder can reduce the complexity of generating private addresses.

In an embodiment, the first frame carries a second random number, and the second random number is associated with a second private address of the initiator; and the generating a first private address based on the first frame and information related to an identity of the first responder includes: generating the first private address based on the second random number and the information related to the identity of the first responder.

The generating the first private address based on the second random number and the information related to the identity of the first responder includes: generating the first private address based on the information related to the identity of the first responder after verifying the identity of the initiator by using the second random number and the second private address; and/or generating the first private address by using the first random and the information related to the identity of the first responder combined with an IRK pre-negotiated between the initiator and the first responder as inputs to a suitable hash function, and the suitable hash function is pre-negotiated between the initiator and the first responder. In the former case, the first frame also carries the second private address.

For example, when the information related to the identity of the first responder includes any one of a public address of the first responder, MMS ranging configuration requested by the first responder, and a first random number generated by the first responder, the generating a first private address based on the second random number and the information related to the identity of the first responder includes: generating the first private address based on the second random number, the information related to the identity of the first responder and a first IRK, and the first IRK is pre-negotiated between the initiator and the first responder.

For example, the first IRK may include: a common IRK shared between the initiator and multiple responders, and the multiple responders include the first responder; or an IRK unique to the initiator and a first responder.

According to the above-mentioned technical solution, the first responder generates a private address based on a random number carried in the compressed frame received from the initiator, which helps to increase the difficulty of a session between an initiator and an authorized responder being attacked, because only responders that know the random number can generate a private address that may be verified successfully by the initiator.

In an embodiment, the second private address is generated based on information related to an identity of a second responder, the generating a first private address based on the first frame and information related to an identity of the first responder includes: generating the first private address when it is determined that the second responder and the first responder are the same responder.

According to the above-mentioned technical solution, it is possible for the initiator to select a particular responder to participate in the MMS ranging.

In an embodiment, the transmitting a second frame carrying the first private address to the initiator includes: transmitting the second frame carrying the first private address and the first random number to the initiator.

Alternatively, the first responder generates a new first random number when transmitting the second frame.

According to the above-mentioned technical solution, carrying the first random number in the second frame enables the initiator to know the first responder's identity, which can avoid the risk of static identity information being stolen and improve communication security.

In an embodiment, the first frame is a ranging initialization message (RIM) frame carrying a list associated with responders that are scheduled to participate in MMS ranging, and the responders include the first responder; the generating a first private address based on information related to an identity of a first responder includes: generating the first private address when it is determined that the first responder is scheduled to the first access slot among multiple access slots based on the list.

According to the above-mentioned technical solution, when responders receive the RIM, only the responder scheduled to the first access slot generates and transmits its private address, while the other responders are on standby until they receive the POLL frame.

In an embodiment, the second frame includes any one of: an ADV-RESP frame, a RESP frame, or a RPRT frame.

The first frame includes an ADV-POLL frame or a POLL frame.

According to the above-mentioned technical solution, carrying a private address related to the responder's identity in the frame transmitted by the responder to the initiator helps the initiator authenticate the identity of the responder.

In an embodiment, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

For example, the time period may be an Insider block structure, or an Outside block structure. Specifically, if the time period is an Insider block structure, the time period may indicate a slot, round, and block in which the secured frame is transmitted.

According to the above-mentioned technical solution, encrypting part of content in the second frame based on a Nonce can help improve the security of the information carried in the second frame.

In an embodiment, the first Nonce includes frame counter information, and the frame counter information indicates the time period for the transmission of the secured frame.

According to the above-mentioned technical solution, based on the time period for transmission of the secured frame, it is possible to generate the frame counter for the Nonce used to secure or unsecure the frames.

In an embodiment, the first Nonce also includes block structure indication information, and the block structure indication information indicates whether the second frame is transmitted inside or outside a block structure.

For example, the block structure indication information includes a 1-bit field, which is set to zero in a compressed frame transmitted outside the block structure and is set to one in a secured compressed frame transmitted inside the block structure.

According to the above-mentioned technical solution, the block structure indication information can ensure that the Nonce used for secured frames transmitted inside and outside the block structure is never reused.

In an embodiment, the second frame further carries a private address of the initiator.

For example, the private address of the initiator includes the second private address.

According to the above-mentioned technical solution, the inclusion of both the initiator's private address and responder's private address in the second frame simplifies the identity verification for the responder. For example, if the initiator's private address carried in the second frame does not match the initiator's private address carried in the first frame, the initiator will determine the identity verification of the responder is unsuccessful, otherwise the initiator will further verify the identity of responder based on the responder's private address. Besides, carrying the initiator's private address in the second frame makes it easier for the initiator to identify the IRK to be used to verify the responder's private address.

In an embodiment, the method further includes: receiving a third frame carrying time-offset information from the initiator, and the time-offset information indicates a time offset of a start of ranging (SOR) frame transmitted.

According to the above-mentioned technical solution, when UWB channel coordination is active, it can make the responder aware of the time offset of the SOR frame.

According to a second aspect, this application provides a communication method. The method is applied to an initiator, and the method includes:
receiving a second frame carrying a first private address from a first responder, and the first private address is associated with information related to an identity of the first responder; generating a third private address based on the information related to the identity of the first responder; and verifying the identity of the first responder by comparing the third private address with the first private address.

Specifically, whether the second frame is truly from the authorized first responder is determined when the third private address is the same as the first private address.

In an embodiment, the information related to the identity of the first responder includes any one of a public address of the first responder, MMS ranging configuration requested by the first responder, a first random number generated by the first responder, and an IRK unique to the initiator and the first responder.

In an embodiment, the method further includes: transmitting a first frame for initiating a ranging process, where the first frame carries a second random number, and the second random number is associated with a second private address of the initiator; and the generating a third private address based on the information related to the identity of the first responder includes: generating the third private address based on the second random number and the information related to the identity of the first responder.

For example, the third private address is generated by using the first random and the information related to the identity of the first responder combined with an IRK pre-negotiated between the initiator and the first responder as inputs to a suitable hash function. The suitable hash function is pre-negotiated between the initiator and the first responder.

In an embodiment, the method further includes: generating a fourth private address based on information related to an identity of a second responder; and transmitting a frame carrying the fourth private address to the second responder.

In some embodiments, the first responder and the second responder are the same responder.

Optionally, the method further includes: transmitting a frame carrying the fourth private address to the first responder. It should be noted that, only the second responder can verify the fourth private address successfully due to the fourth private address is generated based on the second responder's identity.

In an embodiment, the second frame further carries the first random number, the generating a third private address based on the information related to the identity of the first responder includes: generating the third private address based on the first random number.

In an embodiment, the method further includes: transmitting a first frame for initiating a ranging process to the first responder, and the first frame is a RIM frame carrying a list associated with responders that are scheduled to participate in MMS ranging, and the responders include the first responder.

In an embodiment, the second frame includes any one of: an ADV-RESP frame, a RESP frame, or a RPRT frame.

In an embodiment, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

In an embodiment, the first Nonce includes frame counter information, and the frame counter information indicates the time period for the transmission of the secured frame.

In an embodiment, the first Nonce further includes block structure indication information, and the block structure indication information indicates whether the second frame is transmitted inside or outside a block structure.

In an embodiment, the second frame further carries an initiator's private address; the method further includes: verifying the identity of the first responder based on a private address of the initiator.

In an embodiment, the method further includes: transmitting a third frame carrying time-offset information to the first responder, and the time-offset information indicates a time offset of a SOR frame transmitted.

For the beneficial effects of the second aspect, reference is made to the first aspect. Details are not described herein again.

According to a third aspect, this application provides a communication apparatus, including: a receiving unit, configured to receive, from an initiator, a first frame for initiating a ranging process; a generating unit, configured to generate a first private address based on the first frame and information related to an identity of the first responder, and the information related to the identity of the first responder is known to the initiator; and a transmitting unit, configured to transmit a second frame carrying the first private address to the initiator.

In an embodiment, the information related to the identity of the first responder includes any one of: a public address of the first responder, MMS ranging configuration requested by the first responder, a first random number generated by the first responder, or an IRK unique to the initiator and the first responder.

In an embodiment, the first frame carries a second random number, and the second random number is associated with a second private address of the initiator; and the generating unit is configured to: generate the first private address based on the second random number and the information related to the identity of the first responder.

In an embodiment, the second private address is generated based on information related to an identity of a second responder, the generating unit is configured to: generate the first private address when it is determined that the second responder and the first responder are the same responder.

In an embodiment, the transmitting unit is configured to: transmit the second frame carrying the first private address and the first random number to the initiator.

In an embodiment, the first frame is a RIM frame carrying a list associated with responders that are scheduled to participate in an MMS ranging, and the responders include the first responder; and the generating unit is configured to: generate the first private address when it is determined that the first responder is scheduled to the first access slot among multiple access slots based on the list.

In an embodiment, the second frame includes any one of: an ADV-RESP frame, a RESP frame, or a RPRT frame.

In an embodiment, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

In an embodiment, the first Nonce includes frame counter information, and the frame counter information indicates the time period for the transmission of the secured frame.

In an embodiment, the first Nonce further includes block structure indication information, and the block structure indication information indicates whether the second frame is transmitted inside or outside a block structure.

In an embodiment, the second frame further carries a private address of the initiator.

In an embodiment, the receiving unit is further configured to: receive a third frame carrying time-offset information from the initiator, and the time-offset information indicates a time offset of a SOR frame transmitted.

According to a fourth aspect, this application provides a communication apparatus including: a receiving unit, configured to receive a second frame carrying a first private address from a first responder, where the first private address is associated with information related to an identity of the first responder; a generating unit, configured to generate a third private address based on the information related to the identity of the first responder; and a verifying unit, configured to verify the identity of the first responder by comparing the third private address with the first private address.

In an embodiment, the information related to the identity of the first responder includes any one of: a public address of the first responder, MMS ranging configuration requested by the first responder, a first random number generated by the first responder, or an IRK unique to the initiator and the first responder.

In an embodiment, the communication apparatus further includes a transmitting unit configured to: transmit a first frame for initiating a ranging process, and the first frame carries a second random number, and the second random number is associated with a second private address of the initiator; and the generating unit is configured to: generate the third private address based on the second random number and the information related to the identity of the first responder.

In an embodiment, the generating unit is further configured to: generate a fourth private address based on information related to an identity of a second responder; and the transmitting unit is further configured to: transmit a frame carrying the fourth private address to the second responder.

In an embodiment, the second frame further carries the first random number, the generating unit is configured to: generate the third private address based on the first random number.

In an embodiment, the transmitting unit is further configured to: transmit a first frame for initiating a ranging process to the first responder, and the first frame is a RIM frame carrying a list associated with responders that are scheduled to participate in MMS ranging, and the responders include the first responder.

In an embodiment, the second frame includes any one of: an ADV-RESP frame, a RESP frame, or a RPRT frame.

In an embodiment, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

In an embodiment, the first Nonce includes frame counter information, and the frame counter information indicates the time period for the transmission of the secured frame.

In an embodiment, the first Nonce further includes block structure indication information, and the block structure indication information indicates whether the second frame is transmitted inside or outside a block structure.

In an embodiment, the second frame further carries a private address of the initiator; the verifying unit is further configured to: verify the identity of the first responder based on the private address of the initiator.

In an embodiment, the transmitting unit is further configured to: transmit a third frame carrying time-offset information to the first responder, and the time-offset information indicates a time offset of a SOR frame transmitted.

According to a fifth aspect, a communication apparatus including a processor and a memory is provided. The processor is connected to the memory. The memory is configured to store instructions, and the processor is configured to execute the instructions. When the processor executes the instructions stored in the memory, the processor is enabled to perform the method in any possible implementation of the first aspect or the second aspect.

According to a sixth aspect, this application provides a communication system, which includes communication apparatus in any possible implementation of the third aspect, as well as communication apparatus in any possible implementation of the fourth aspect.

According to a seventh aspect, this application provides a computer readable storage medium, which includes instructions. When the instructions run on a processor, the processor is enabled to perform the method in any possible implementation of the first aspect or the second aspect.

According to an eighth aspect, this application provides a computer program product, which includes computer program code. When the computer program code runs on a computer, the computer is enabled to perform the method in any possible implementation of the first aspect or the second aspect.

It should be noted that all or a part of the above computer program code can be stored in on a first storage medium. The first storage medium can be packaged together with the processor or separately with the processor.

According to a ninth aspect, this application provides a chip system, which includes a memory and a processor. The memory is configured to store a computer program, and the processor is configured to invoke the computer program from the memory and run the computer program, so that an electronic device on which the chip system is disposed performs the method in any possible implementation of the first aspect or the second aspect.

### DESCRIPTION OF DRAWINGS

FIG. 1 illustrates transmission of compressed frames in an MMS ranging session.

FIG. 2 is a schematic flowchart of a communication method according to an embodiment of the present application.

FIG. 3 is a schematic flowchart of another communication method according to an embodiment of the present application.

FIG. 4 is a schematic diagram of an ADV-POLL frame or a POLL frame.

FIG. 5 is a schematic diagram of an ADV-RESP frame or a RESP frame according to an embodiment of the present application.

FIG. 6 is a schematic diagram of another ADV-RESP frame or another RESP frame according to an embodiment of the present application.

FIG. 7 is a schematic diagram of still another ADV-RESP frame or still another RESP frame according to an embodiment of the present application.

FIG. 8 is a schematic diagram of a SOR frame.

FIG. 9 is a schematic diagram of a secured compressed frame according to an embodiment of the present application.

FIG. 10 is a schematic diagram of a Nonce according to an embodiment of the present application.

FIG. 11 is a schematic diagram of a method for constructing a Nonce according to an embodiment of the present application.

FIG. 12 is a schematic flowchart of still another communication method according to an embodiment of the present application.

FIG. 13 is a schematic flowchart of yet another communication method according to an embodiment of the present application.

FIG. 14 is a schematic flowchart of yet another communication method according to an embodiment of the present application.

FIG. 15 is a schematic flowchart of yet another communication method according to an embodiment of the present application.

FIG. 16 is a schematic diagram of a RIM frame according to an embodiment of the present application.

FIG. 17 is a schematic flowchart of yet another communication method with selective MMS ranging according to an embodiment of the present application.

FIG. 18 is a schematic block diagram of a communication apparatus according to an embodiment of the present application.

FIG. 19 is a schematic block diagram of another communication apparatus according to an embodiment of the present application.

FIG. 20 is a schematic block diagram of still another communication apparatus according to an embodiment of the present application.

### DESCRIPTION OF EMBODIMENTS

For ease of understanding, the following illustrates an MMS ranging session.

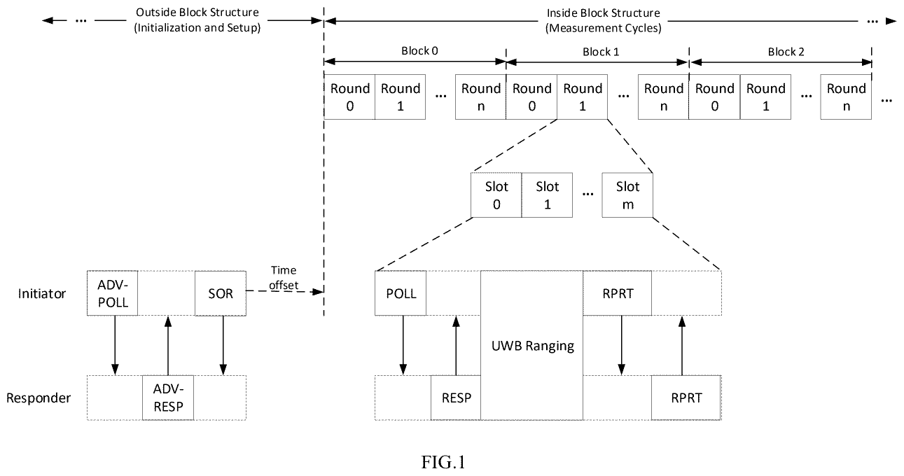

As shown in FIG. 1, an MMS ranging session may include an initialization and setup phase followed by one or more range measurement cycles. During the initialization and setup phase, the frames are transmitted in an initialization channel, while during the measurement cycles, the frames are transmitted in a ranging channel. While it is possible to use the same channel as both the initialization channel and the ranging channel, it is more likely that one or more well-known channels will be used as the initialization channel.

In the initialization and setup phase, initiators and responders may negotiate ranging configuration. An initiator transmits ADV-POLL frames opportunistically at times and intervals to its discretion while responder(s) may opportunistically listen for incoming ADV-POLL frames and respond with an ADV-RESP frame if the responder intends to participate in a ranging session with the initiator. Once the initiator has received an ADV-RESP frame, it transmits a SOR frame that provides the time offset at which the first range-measurement cycle will start.

A measurement cycle comprises a ranging control phase, a ranging phase, and an optional measurement report phase. A ranging control phase starts at the beginning of a range-measurement cycle. An initiator starts the ranging control phase by transmitting a POLL frame to a responder at the beginning of the first ranging slot of a ranging round. A responder that receives the POLL frame successfully transmits a RESP frame back to the initiator. The POLL and RESP frames allow the initiator and responder to achieve time and frequency synchronization. An initiator may also include other control information in the POLL frame for the responder. In the ranging phase, the initiator and responder may exchange zero or more UWB ranging sequence fragments (RSF) and optionally one or more UWB ranging integrity fragments (RIF). The RSFs are used to perform ranging measurements while the RIFs are used to check the integrity of the ranging measurements. After the initiator or the responder, completes the reception of all UWB fragments for the ranging phase, the report phase starts in which the initiator and/or the responder generate a ranging measurement report, and transmit the RPRT frame carries the measurement report to the peer device.

MMS ranging comes in two flavors: 1) UWB only MMS ranging, in which the control frames as well as the ranging fragments are transmitted using UWB; and 2) narrowband assisted UWB (NBA-UWB) MMS ranging, in which the ranging fragments are transmitted using UWB while the control signals are transmitted using narrow band.

The transmission of frames in MMS ranging sessions is based on the block-based time structure. As shown in FIG. 1, the frames are transmitted outside a block structure during the initialization and setup phase, and the frames are transmitted inside a block structure during the measurement cycles. In the block-based time structure, each ranging block consists of a whole number of ranging rounds, where a ranging round is a period of sufficient duration to complete one entire range-measurement cycle involving the set of enhanced ranging capable devices (ERDEVs) participating in the ranging exchange. Here, when a frame is said to be transmitted or received Inside block structure, it means that both the initiator and the responder are aware of the block-based time structure and are in sync. However, if either one or both is not aware of the block-based time the frame is said to be transmitted or received Outside block structure. Each ranging round is further subdivided into an integer number of ranging slots where a ranging slot is a time period of sufficient duration for the transmission of at least one ranging frame (RFRAME). The block-based mode uses a structured timeline where the ranging block structure is periodic by default.

The following describes the technical solutions in this application with reference to the accompanying drawings.

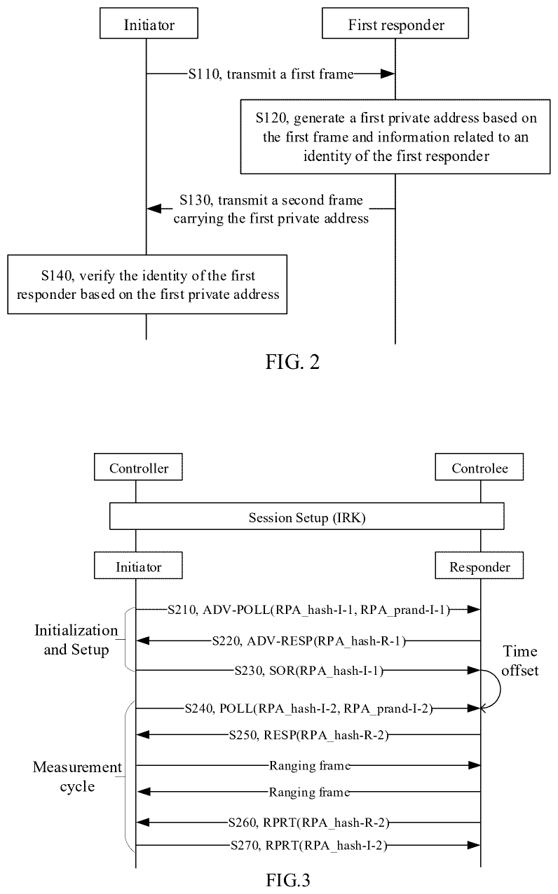

FIG. 2 illustrates a flowchart of an embodiment a communication method. The method may be applied to an MMS ranging process. An initiator may be a device that initiates a UWB exchange by transmitting a message of the exchange. A responder may be a device that responds to the message received from the initiator and participates in the UWB exchange.

S110: The initiator transmits a first frame to a first responder.

The first frame carries a second random number and a second private address of the initiator, where the second private address is associated with the second random number. For example, the second private address is generated by using a hash function over the second random number combined with a second IRK, and the second IRK is pre-negotiated between the initiator and the first responder.

In some embodiments, the first frame is used to initiate a ranging process. For example, the first frame may be one of an ADV-POLL frame, a POLL frame, and a RIM frame. The RIM frame can be regarded as a variation of the POLL frame.

S120: The first responder generates a first private address based on the first frame and information related to an identity of the first responder.

The information related to the identity of the first responder is known to the initiator. For example, the information related to the identity of the first responder is pre-negotiated between the initiator and the first responder, or the information related to the identity of the first responder is the first responder informs the initiator. For the former situation, the information related to the identity of the first responder includes any one of a public address of the first responder and an IRK unique to the initiator and the first responder (e.g., IRK-RI). For the latter situation, the information related to the identity of the first responder includes any one of MMS ranging configuration requested by the first responder and a first random number generated by the first responder.

For example, the first responder's public address includes an in band extended address or an OOB public address.

For example, the in band extended address may include 8 octets extended media access control (MAC) address. The OOB public address may include 6 octets Bluetooth MAC address. In some embodiments, the first responder's public address may also include other communication addresses that uniquely identify the first responder.

For example, the first responder's requested MMS ranging configuration may include at least one of the following: UWB physical layer (PHY) configuration, UWB MAC configuration, narrowband (NB) PHY configuration, and NB MAC configuration.

Optionally, the first responder generates a first private address based on the first frame and information related to an identity of the first responder includes: the first responder generates the first private address based on the second random number and the information related to the identity of the first responder.

In some embodiments, the first responder generates the first private address based on the second random number and the information related to the identity of the first responder includes: the first responder generates the first private address by using the first random and the information related to the identity of the first responder combined with a first IRK pre-negotiated between the initiator and the first responder as inputs to a suitable hash function; or the first responder generates the first private address by using the first random and the information related to the identity of the first responder as inputs to a suitable hash function. The suitable hash function was pre-negotiated between the initiator and the first responder.

For example, the first private address may be generated by using an equation as follow: Hash=AH(IRK, random number), and the Hash represents the first private address, AH( ) represents a hash function, IRK can be the first IRK or the IRK unique to the initiator and the first responder, and random number can be the second random number or the first random number.

For example, the first IRK includes: a common IRK shared between the initiator and multiple responders, and the multiple responders include the first responder; or an IRK unique to the initiator and a first responder.

Optionally, the second IRK and the first IRK are the same, or the second IRK and the first IRK are pairwise.

In other embodiments, the first responder generates the first private address based on the second random number and the information related to the identity of the first responder includes: the first responder generates the first private address based on the information related to the identity of the first responder after verified the identity of the initiator by using the second random number and the second private address.

For example, the first responder verifies the identity of the initiator by using the second random number and the second private address, includes: the first responder verifies the identity of the initiator by using the second IRK, the second random number, and the second private address. Specifically, the first responder generates a local private address of the second random number using the first IRK. The first responder will determine the identity verification of the initiator is successful if the local private address matches the second private address carried in the first frame, otherwise the first responder will discard the first frame.

S130: The first responder transmits a second frame carrying the first private address to the initiator.

For example, the second frame may be one of an ADV-RESP frame and a RESP frame, and a RPRT frame.

In some embodiments, if the first private address is generated based on the first random number, the second frame will carry the first private address and the first random number.

In some embodiments, the second frame also carries the second private address.

S140: The initiator verifies the identity of the first responder based on the first private address.

For example, the initiator verifies the identity of the first responder by using the information related to the identity of the first responder and the first IRK, which is pre-negotiated between the initiator and the first responder. Specifically, the initiator generates a local private address (e.g., a third private address) of the specific random number by using the first IRK and the information related to the identity of the first responder. The initiator will determine the identity verification of the first responder is successful if the local private address matches the first private address carried in the second frame, otherwise the initiator will discard the second frame.

For example, the specific random number may include the first random number or the second random number. The specific random number includes the first random number when the first private address is generated based on the first random number. The specific random number includes the second random number when the first private address is generated based on the second random number.

In some embodiments, the initiator generates the second private address based on information related to an identity of a second responder. The first responder generates a local private address based on the information related to an identity of the second responder. If the first responder is able to verify the second private address successfully, then the first responder determines that the second responder is the same as the first responder and generates the first private address.

In some embodiments, the initiator generates a fourth private address based on information related to an identity of a second responder and transmits frames carrying the fourth private address to the second responder and the first responder. It should be noted that only the second responder can verify the fourth private address successfully due to the fourth private address is generated based on the second responder's identity.

Optionally, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

For example, the first responder generates the first Nonce based on the ID field and private address field of the second frame as well as a slot, round, and block in which the second frame is transmitted.

Optionally, the first Nonce includes frame counter information, and the frame counter information indicates the slot, round, and block in which the second frame is transmitted.

Optionally, the first Nonce also includes block structure indication information, and the block structure indication information indicates whether the second frame is transmitted inside or outside a block structure.

It should be noted that the first frame and the second frame are compressed frames in the present application. The compressed frame is either a compressed PSDU or an IEEE Standard 802.15.4 frame using the compressed header information element (Header IE) format.

In some embodiments, a controller assumes the role of the initiator while the controlee is assigned the role of the first responder, however it is also possible that the controlee may be assigned the role of the initiator while the controller assumes the role of the first responder. It should be noted that the controller is a device used to control the UWB session and define the session parameters, and the controlee is a device that utilizes the session parameters received from the controller to participate in the UWB session.

The communication method provided in embodiments of the present application in a one-to-one MMS ranging session is described below in detail with reference to FIG. 3 to FIG. 12. The embodiments shown in FIG. 3 to FIG. 12 are illustrated with a controller as an initiator and a controlee as a responder as examples.

FIG. 3 illustrates a schematic flowchart of a communication method in one-to-one MMS ranging according to an embodiment of the present application. The method shown in FIG. 3 includes a session setup phase and operations S210 to S270.

An MMS ranging session begins with a controller and a controlee performing a session setup during which the long-term session parameters such as UWB channel number, preamble codes, block structure, and so on are negotiated. Specifically, at least one IRK will also be provided by the controller to the controlee to resolve or create the private addresses during the session setup. Besides, for NBA-UWB MMS ranging, parameters related to narrow bands such as the NB channel number and the number of MMS fragments may also be negotiated during the session setup. Additionally, the initiator and responder roles may also be assigned during the session setup.

For example, at least one IRK may include at least one of the first IRK and the second IRK in the above embodiment.

Understandably, the long-term parameters are not expected to change during an MMS ranging session.

In contrast, the parameters related to a measurement cycle such as round/slot durations, number of MMS fragments, report modes, etc. may be considered as short-term parameters and may be modified during an MMS ranging session.

The session setup may be performed out-of-band, for example using Bluetooth or Wi-Fi radio, or may also be performed in-band, for example using NB or UWB radio.

Once the session has been set up, operation S210 is performed.

S210: An initiator transmits an ADV-POLL frame.

For example, the initiator transmits the ADV-POLL frames opportunistically at times and intervals to its discretion while responder(s) may opportunistically listen for incoming ADV-POLL frames. An ADV-POLL frame may carry a pseudo random number RPA_prand-I-1 and its private address RPA_hash-I-1, and the RPA_hash-I-1 can be regarded as an example of the second private address in the above embodiment.

For example, the RPA_hash-I-1 may be computed and truncated to 24 bits by using Equation 1:

$$Equation 1$$

$$RPA\_hash - I - 1 = AES - 128 - \text{} ECB ( key = IRK , data = ( 0 x 000 … [ 13 ] ‖ \text{} PA\_prand - I - 1 [ 3 ] ) ) \% 2 \hat{} 24$$

AES-128-ECB is a hash function, which can also be replaced by other hash functions. [n] indicates that its preceding parameter is n octets.

The IRK may be a common IRK pre-negotiated, for example, IRK-B, between the initiator and the responder.

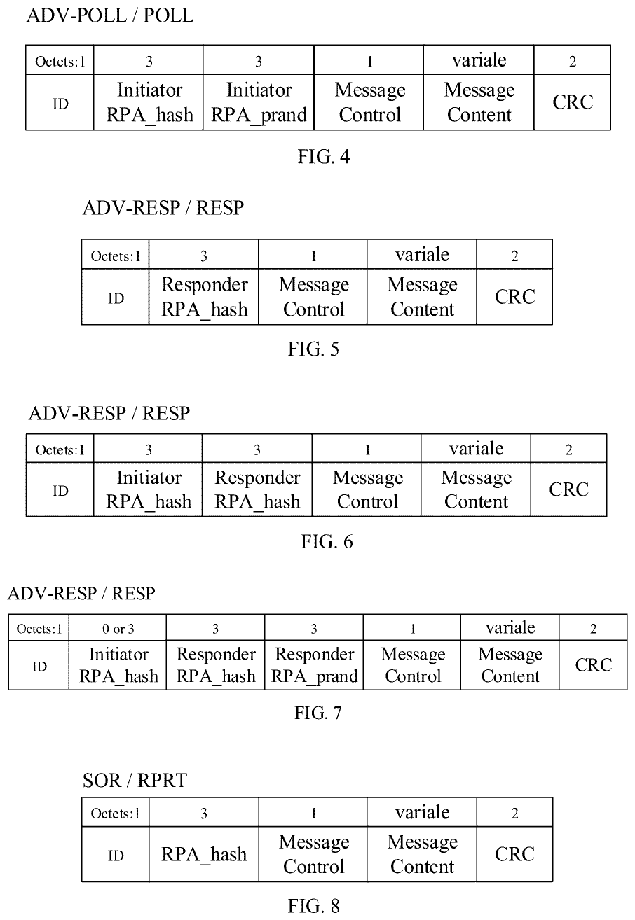

A schematic diagram of an ADV-POLL frame is illustrated in FIG. 4. As shown in FIG. 4, an ADV-POLL frame is composed of: a 1-octet message ID field, a 3-octets private address field that carries the Initiator RPA_hash (e.g., RPA_hash-I-1), a 3-octets field that carries the Initiator RPA_prand (e.g., RPA_prand-I-1), a one octet MessageControl field that determines the format of the MessageContent field, a variable length MessageContent field whose format depends on the content of the MessageContent field, and a 2-octets cyclic redundancy check (CRC) field. The Initiator RPA_hash may also be termed as initiator's RPA_hash or initiator's private address. The Initiator RPA_prand may also be termed as initiator's RPA_prand or initiator's random number.

Upon receiving the ADV-POLL frame, the responder generates a local hash of the RPA_prand-I-1 by using the pre-negotiated IRK, such as the above IRK-B. For example, the responder generates the local hash of the RPA_prand-I-1 by using the IRK-B as input to Equation 1. Furthermore, if the local hash does not match the RPA_hash-I-1 carried in the ADV-POLL frame, the responder will discard the ADV-POLL frame; otherwise, the responder will determine the identity verification of the initiator is successful, and then the responder will transmit an ADV-RESP frame to the initiator if the responder intends to participate in a ranging session with the initiator as illustrated in operation S220.

S220: The responder transmits an ADV-RESP frame to the initiator.

Specifically, the ADV-RESP frame carries a private address that can identify the responder, i.e., RPA_hash-R-I, which is generated by using information related to the responder's identity. The RPA_hash-R-I can be regarded as an example of the first private address in the above embodiment.

Once the initiator has received the ADV-RESP frame, the initiator verifies the identity of the responder based on the RPA_hash-R-1.

In one embodiment, the information related to the responder's identity may include the responder's public address Responder MAC Address, such as 8 octets extended 802.15 MAC address, then RPA_hash-R-I may be computed and truncated to 24 bits by using Equation 2:

$$Equation 2$$

$$RPA\_hash - R - 1 = AES - 128 - ECB ( key = IRK , data = ( 0 x 000 … [ 5 ] ‖ Responder MAC Address [ 8 ] ‖ RPA\_prand - I - 1 ] ) \% 2 \hat{} 24$$

Furthermore, once the initiator has received the ADV-RESP frame, the initiator generates a local hash for the responder using the responders' public address (e.g., 8 octets extended 802.15 MAC address) combined with the RPA_prand-I-1 carried in the ADV-POLL and using the IRK as inputs to Equation 2.

In another embodiment, the information related to the responder's identity may include MMS ranging configuration requested by the responder, such as the various NB and UWB configuration requested by the responder in the ADV-RESP frame, then RPA_hash-R-I may be computed and truncated to 24 bits by the using the following Equation 3:

$$Equation 3$$

$$RPA\_hash - R - 1 = AES - 128 - ECB ( key = IRK , data = ( 0 x 00 [ 1 ] ‖ UWB PHY Config ‖ UWB MAC \text{} Config ‖ NB PHY Config ‖ NB MAC Config ‖ RPA\_prand - I - 1 ] ) \% 2 \hat{} 24$$

Here, UWB PHY Config, UWB MAC Config, NB PHY Config, and NB MAC Config refer to the various configuration parameters carried in the MessageContent field of the ADV-RESP frame.

It should be noted that as long as there is at least 1-bit difference in the configuration requested by different responders, the responder's private address will be unique and can be used to identify the responder in subsequent frames.

Furthermore, once the initiator has received the ADV-RESP frame, the initiator generates a local hash for the responder using the configuration parameters carried in the MessageContent field of the ADV-RESP frame combined with the RPA_prand-I-1 and using the IRK as inputs to above Equation 3.

In still another embodiment, the information related to the responder's identity may include the responder's public address Responder OOB MAC Address, such as 6 octets Bluetooth MAC address, then RPA_hash-R-1 may be computed and truncated to 24 bits by using Equation 4:

$$Equation 4$$

$$RPA\_hash - R - 1 = AES - 128 - ECB ( key = IRK , data = ( 0 x 000 … [ 7 ] ‖ , 6 octets Bluetooth MAC address [ 6 ] ‖ RPA\_prand - I - 1 ] ) \% 2 \hat{} 24$$

Furthermore, once the initiator has received the ADV-RESP frame, the initiator generates a local hash for the responder using the responders' public address (e.g., 6 octets Bluetooth MAC address) combined with the RPA_prand-I-1 and using the IRK as inputs to Equation 4.

In some embodiments, the initiator would maintain a record of the public address of the responder(s) during the session setup.

In yet another embodiment, the information related to the responder's identity may include one IRK (e.g. IRK-RI) of the pairwise IRK (e.g. IRK-RI & IRK-IR) unique to the initiator and the first responder and used for frames transmitted by the responder to the initiator, then RPA_hash-R-I may be computed and truncated to 24 bits by using Equation 5:

$$Equation 5$$

$$RPA\_hash - R - 1 = AES - 128 - \text{} ECB ( key = IRK - RI , data = ( 0 x 000 … [ 13 ] ‖ Initiator RPA\_prand - I - 1 ] ) \% 2 \hat{} 24$$

Furthermore, once the initiator has received the ADV-RESP frame, the initiator generates a local hash for the responder using the IRK-RI combined with the RPA_prand-I-1 as inputs to Equation 5.

A schematic diagram of an ADV-RESP frame carrying the responder's private address (e.g., RPA_hash-R-1) generated by any one of the above Equations 2 to 5 is illustrated in FIG. 5. As shown in FIG. 5, an ADV-RESP frame is composed of: a 1-octet message ID field, a 3-octets field that carries the responder's private address (e.g., RPA_hash-R-1), a one octet MessageControl field that determines the format of the MessageContent field, a variable length MessageContent field whose format depends on the content of the MessageContent field, and a 2-octets CRC field.

In some embodiments, the ADV-RESP frame also carries the private address obtained from the ADV-POLL, which is Initiator RPA_hash. A schematic diagram of an ADV-RESP frame carrying the responder's private address and the initiator's private address is illustrated in FIG. 6.

The inclusion of both the Initiator RPA_hash and the Responder RPA_hash in the ADV-RESP frame makes it easier to identify the associated IRK and simplifies the identity verification of the initiator to the responder. Specifically, if the Initiator RPA_hash carried in the ADV-RESP frame does not match the Initiator RPA_hash carried in the ADV-POLL frame, the initiator will determine the identity verification of the responder is unsuccessful, otherwise the initiator will further verify the identity of the responder based on the Responder RPA_hash. The Responder RPA_hash may also be termed as responder's RPA_hash or responder's private address.

In some embodiments, the information related to the responder's identity may include the random number (e.g. RPA_prand-R-1) generated by the responder, then RPA_hash-R-I may be computed and truncated to 24 bits by using Equation 6:

$$Equation 6$$

$$RPA\_hash - R - 1 = AES - 128 - \text{} ECB ( key = IRK , data = ( 0 x 000 … [ 13 ] ‖ \text{} RPA\_prand - R - 1 ) ) \% 2 \hat{} 24$$

For example, the responder generates its own pseudo random number RPA_prand-R-1 using any suitable pseudo random generator function.

In one embodiment, the responder generates the RPA_prand-R-I when the responder has successfully verified the identity of the initiator.

In another embodiment, the responder generates the RPA_prand-R-I every time the ADV-RESR and RESP frames are transmitted.

Besides, the ADV-RESP frame also needs to carry the responder's random number if the RPA_hash-R-I is generated by using Equation 6, so that the initiator can verify the identity of the responder. The schematic diagram of an ADV-RESP frame carrying the responder's private address and responder's random number is illustrated in FIG. 7. Optionally, the frame shown in FIG. 7 may carry the initiator's private address obtained from the ADV-POLL or not.

It should be noted that the different formats of the ADV-RESP or RESP frames may be differentiated by using different IDs for the frames, e.g., 0×02 for the format shown in FIG. 5, 0×32 for the format shown in FIGS. 6 and 0×42 for the format shown in FIG. 7 etc.

It should be noted that the IRK used in Equations 2 to 4 and Equation 6 may be the first IRK in the foregoing embodiment. For example, the IRK used in Equations 2 to 4 and Equation 6 may be a common IRK (e.g., IRK-B), or the IRK used in Equations 2 to 4 and Equation 6 may be one of the pairwise IRK (e.g., IRK-RI). Besides, Equations 2 to 6 can be regarded as some specific examples of Hash=AH(IRK, random number).

Furthermore, if the local hash for the responder does not match the RPA_hash-R-1 carried in the ADV-RESP frame, the initiator will discard the ADV-RESP frame; otherwise, the initiator will determine the identity verification of the responder is successful, and then the initiator will transmit a SOR frame to the responder as illustrated in operation S230.

S230: The initiator transmits a SOR frame to the responder.

Specifically, the SOR frame provides the time offset at which the first range-measurement cycle will start. The SOR frame carries the same RPA_hash-I-1 contained in the ADV-POLL frame.

A schematic diagram of a SOR frame is illustrated in FIG. 8. As shown in FIG. 8, an SOR frame is composed of: a 1-octet message ID field, a 3-octets private address field that carries the Initiator RPA_hash (e.g., RPA_hash-I-1), a 1-octet MessageControl field that determines the format of the MessageContent field, a variable length MessageContent field whose format depends on the content of the MessageContent field, and a 2-octets CRC field. The SOR frame carries a time offset that indicates the time at which the measurement phase of the MMS ranging will start. S240: The initiator transmits a POLL frame to the responder.

At the time indicated by the time offset in the SOR frame, the initiator transmits a POLL frame to the responder at the beginning of the first ranging slot of a ranging round.

For example, the POLL frame shares the same format illustrated in FIG. 4 and carries a pseudo random number RPA_prand-I-2 and its private address, RPA_hash-I-2 that is generated using RPA_prand-I-2 and the IRK as inputs to Equation 1.

Upon receiving the POLL frame, the responder verifies the identity of the initiator based on the private address carried in the POLL frame. Reference is made to the verification method based on the ADV-POLL frame in S210 for specific verification method. Details are not described herein again.

The responder will transmit a RESP frame to the initiator, as illustrated in operation S250, when the identity verification of the initiator is successful.

S250: The responder transmits a RESP frame to the initiator.

Specifically, the RESP frame carries the responder's private address, such as RPA_hash-R-2. Reference is made to the detailed description in S220 for the method of generating the responder's private addresses, the format of the RESP frame, and the method of verifying the responder's identity based on the RESP frame by the initiator. The method is the same except that the pseudo random number carried in the POLL frame (e.g., RPA_prand-I-2) is used to generate the Responder RPA_hash. In short, when generating RPA_hash-R-2 using an aforementioned equation, the RPA_prand-I-1 in the related equation is replaced with RPA_prand-I-2. Details are not described herein again.

When the identity verification of the responder is successful, the initiator initiates the ranging phase in which the initiator and responder exchange zero or more RSF and optionally one or more RIF.

After the initiator or the responder completes the reception of all UWB fragments for the ranging phase, the initiator and/or the responder generate a ranging measurement report, and transmit the RPRT frame that carries the measurement report to the peer device as illustrated in operation S260 and S270.

S260: The responder transmits a RPPT frame to the initiator.

For example, the RPRT frame in this operation shares the same format illustrated in FIG. 8 and carries a private address, RPA_hash-R-2 that is generated in operation S250.

S270: The initiator transmits a RPPT frame to the responder.

For example, the RPRT frame in this operation shares the same format illustrated in FIG. 8 and carries a private address, RPA_hash-I-2 that is generated in operation S240.

Considering the sensitive nature of some information carried in the above frames, a secured compressed frame is provided in the embodiment of the present application to improve the security of information.

It should be noted that the secured compressed frame in the present application is a compressed frame that is secured using a cryptographic operation such as authentication or encryption.

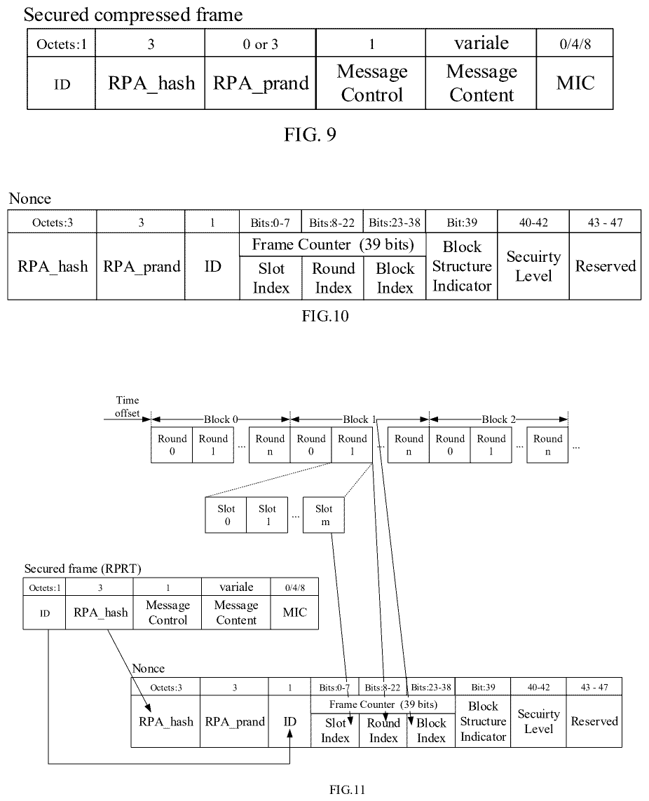

FIG. 9 illustrates a schematic diagram of a secured compressed frame. As shown in FIG. 9, the fields of a secured compressed frame are as follows:
1. The ID field indicates the identity of the secured version of the compressed frame, for example, ID space 0×60 to 0×6F may be reserved for secured versions of compressed frames and 0×60 represents the secured ADV-RESP frame, 0×61 represent the secured version of the SOR frame, 0×65 and 0×66 represent the secured version of the RPRT frame transmitted by the initiator and responder respectively. The RPRT frame may also be termed as REPORT frame.
2. A 3-octets private address field that carries the RPA_hash.
3. An optional 3-octets field that carries the RPA_prand. The field may be only present in certain frames (e.g., ADV-POLL or POLL) and absent in other compressed PSDUs (e.g., ADV-RESP, RESP, SOR, REPORT).
4. A 1-octet MessageControl field that determines the format of the MessageContent field.
5. A variable length MessageContent field whose format depends on the content of the MessageContent field. All or part of the MessageContent field will be encrypted if a security level for encryption is chosen. If only a part of the MessageContent field is encrypted, the sub-fields to be encrypted (also known as the private payload field) will be placed at the end of the MessageContent field while the sub-fields that are not encrypted (also known as the open payload field) are placed at the beginning of the MessageContent field.
6. A variable length message integrity check (MIC) field replaces the CRC field. The length of the MIC depends on the security level. For example, the length of the MIC may be one of 0 octet, 4 octets, and 8 octets. When the length of the MIC is 0 octets, the frame is not secured and the field is used for the 2-octet CRC.

In some embodiments, all or part of the content in the MessageContent field can be encrypted by authenticated encryption with associated data (AEAD) operation based on a Nonce.

It should be noted that when security is enabled, one or more secret keys different from the IRK may be exchanged between the initiator and responder(s) used for the AEAD operation.

The Nonce used for the AEAD transformation or inverse transformation of a secured compressed frame is illustrated in FIG. 10. This Nonce format may be used for compressed frame transmitted outside the block or inside the block structure. As shown in FIG. 10, the fields of a Nonce are as follows:
1. The RPA_hash field is set to the RPA_hash field of the compressed frame to be secured or unsecured.
2. The RPA_prand field is set to the RPA_prand field of the compressed frame to be secured, if such a field exists, else it is set as the RPA_prand that is used to generate the RPA_hash field of the compressed frame to be secured or unsecured.
3. The ID field is set to the ID field of the compressed frame to be secured or unsecured.
4. If a block structure exists and is known to both the transmitting and the receiving device (e.g., Inside block structure in FIG. 1), the Frame Counter field includes the Slot Index field, Round Index field and the Block Index field which are set as the indices of the slot, round and block in which the frame is transmitted or received respectively. If a block structure does not exist and or is not known to at least one of the transmitting or the receiving device (e.g., Outside block structure in FIG. 1), the Frame Counter field is reserved and set to 0. The information carried in the Frame Counter field can be regarded as an example of frame counter information.
5. A 1-bit field called Block Structure Indicator indicates whether the secured frame is transmitted inside or outside a block structure. For example, the Block Structure Indicator field is set to zero in a secured compressed frame transmitted outside the block structure and is set to one in a secured compressed frame transmitted inside the block structure. The information carried in the Block Structure Indicator field can be regarded as an example of block structure indication information.
6. The Security Level field is an unsigned integer that shall be set to the value of the security level negotiated during session setup.

Besides, FIG. 11 illustrates how the Nonce is constructed for the security operation related to a secured compressed frame transmitted inside the block structure according to an embodiment of the present application.

Once a device is synchronized to the block structure, it knows the slot/round/block index where the compressed frame is transmitted or received, and it can construct the Frame Counter field of the Nonce, else the Frame Counter field is set as 0. For the example illustrated in FIG. 11, for a RPRT frame transmitted by the responder in the slot m of the round 1 of the block 1, the Slot Index field, the Round Index field and the Block Index field of the Frame Counter field of the Nonce are separately set as m, 1 and 1 corresponding to slot m, round 1 and block 1; while the Block Structure Indicator is set as one. The RPA_hash field and the e ID field of the Nonce are copied over from the RPA_hash field and the ID field of the REPORT frame. However, since the RPA_prand field does not exist in the REPORT frame, the RPA_prand field of the Nonce is set as the RPA_prand used to generate the RPA_hash field, for example, the RPA_prand carried in the preceding POLL frame transmitted by the initiator. The Nonce Security Level is set to the appropriate security level, for example, the security level negotiated during session setup.

Similarly, for a frame transmitted outside the block structure, for example, an SOR frame, the Frame Counter field of the Nonce is all set to 0; while the Block Structure Indicator is set as zero. The RPA_hash field and the Message ID field of the Nonce are copied over from the RPA_hash field and the ID field of the SOR frame. Since the RPA_prand field does not exist in the SOR frame, the RPA_prand field of the Nonce is set as the RPA_prand used to generate the RPA_hash field, i.e., the RPA_prand carried in the preceding ADV-POLL frame transmitted by the initiator. The Nonce Security Level is set to the appropriate security level, for example, the security level negotiated during session setup.

For example, to secure or unsecure the compressed frames, the procedures given in 9.3.5 (AEAD transformation data representation) or 9.3.6 (AEAD inverse transformation data representation) in the 802.15.4-2020 specification are reused, except that for the compressed frames the MAC header (MHR) is replaced by the ID field, the RPA_hash field, the RPA_prand field (if present) and the MessageControl field.

While in most secured compressed frames, the whole MessageControl field is considered the Private Payload field and will be encrypted if any security level with encryption is negotiated, however for the secured RPRT compressed frames (SECURE-RPRT), only selected fields of the MessageControl field may be considered to be the Private Payload field and will be encrypted if any security level with encryption is negotiated. This is summarized in the Table 1:

TABLE 1

| Frame type | Private Payload field | Open Payload field |
|---|---|---|
| SECURE-RPRT | TurnAroundTime | All other fields in the |
| (from initiator) | | MessageContent field |
| SECURE-RPRT | Any of the following | All other fields in the |
| (from responder) | fields if present, | MessageContent field |
| | and in this order: | |
| | ReplyTime | |
| | NbaChannelMap | |
| | UWB PHY Config | |
| | UWB MAC Config | |
| | NB PHY Config | |
| All other secured | MessageContent | Empty |
| compressed PSDUs | | |

In the above embodiment, the security of communication during MMS ranging can be further improved by encrypting the compressed frame.

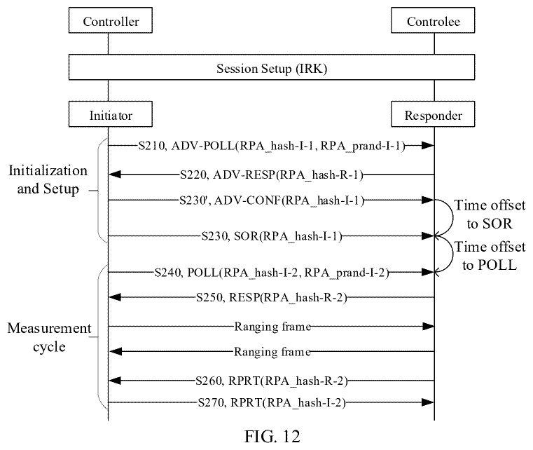

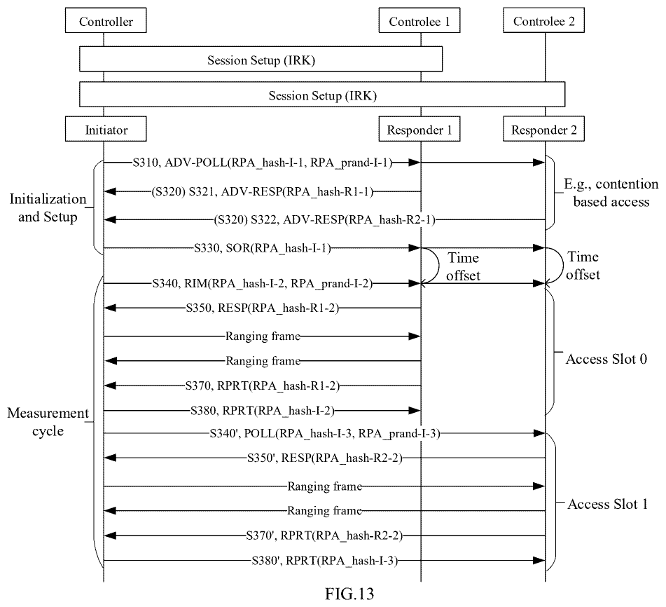

In some embodiments, UWB channel coordination may be active and prior to transmitting the SOR frame, the initiator scans the initialization channels in NB and the default UWB channels for acquisition packets (APs) from other initiators. In order to perform the acquisition scan, upon receiving the ADV-RESP frame from the responder, instead of immediately transmitting the SOR frame, the initiator transmits to the responder an advertising confirmation (ADV-CONF) frame that carries a time offset indicating the transmission time of the SOR, as shown in operation S230′ in FIG. 12 and the initiator performs the acquisition scan for the APs. Based on the information gathered from the APs, the initiator can adapt the configuration parameters for the MMS ranging in the SOR frame.

The communication method provided in the embodiments of the present application can also be applied in one-to-many MMS ranging sessions. FIG. 13 to FIG. 15 illustrate schematic flowcharts of a communication method in one-to-many MMS ranging according to an embodiment of the present application.

As shown in FIG. 13, similar to the one-to-one MMS ranging, a one-to-many MMS ranging session begins with a controller and the two controlees performing session setups during which the long-term session parameters such as the UWB channel number, preamble codes, block structures are negotiated. When privacy is enabled, at least one IRK will also be provided by the controller to each of the controlees to resolve the private addresses carried in the frames transmitted by the initiator and also to generate the private addresses to be included in the frames transmitted by the responders, thereby protecting the privacy of the devices.

Once the session has been set up, operation S310 is performed.

S310: An initiator transmits ADV-POLL frames.

For example, the initiator transmits the ADV-POLL frames opportunistically at times and intervals to its discretion while the responders may opportunistically listen for incoming ADV-POLL frames.

Specifically, for the method of generating initiator's private addresses carried in ADV-POLL frames and the format of ADV-POLL frame, reference is made to the foregoing embodiments. Details are not described herein again.

When the initiator expects more than one responder to participate in the MMS ranging, the initiator allocates a fixed duration for the responders to contend the medium and transmit their respective ADV-RESP frames.

Upon receiving the ADV-POLL frame, Responder 1 or Responder 2 verifies the identity of the initiator. For the method of verifying the identity of the initiator, reference is made to the foregoing embodiments. Details are not described herein again.

When the identity verification of the initiator is successful, Responder 1 and Responder 2 will transmit an ADV-RESP frame to the initiator if they intend to participate in a ranging session with the initiator as illustrated in operation S320. Specifically, S320 includes S321 and S322.

S321: Responder 1 transmits an AVD-RESP carrying its private address, RPA_hash-RI-I to the initiator.

S322: Responder 2 transmits an AVD-RESP carrying its private address, RPA_hash-R2-1 to the initiator.

For method of generating the private address, refer to the foregoing embodiments. Details are not described herein again.

S330: The initiator transmits a SOR frame to Responder 1 and Responder 2.

The initiator generates local hashes by the method in the foregoing embodiment. If at least one of the local hashes matches either one of RPA_hash-R1-1 or RPA_hash-R2-1, the initiator transmits the SOR frame that provides the time offset at which the first range-measurement cycle will start. The SOR frame carries the same RPA_hash-I-1 contained in the ADV-POLL frame. S340: The initiator transmits a RIM frame to Responder 1 and Responder 2.

At the time indicated by the time offset in the SOR frame, the initiator transmits a RIM frame to the responders at the beginning of the first ranging slot of a ranging round.

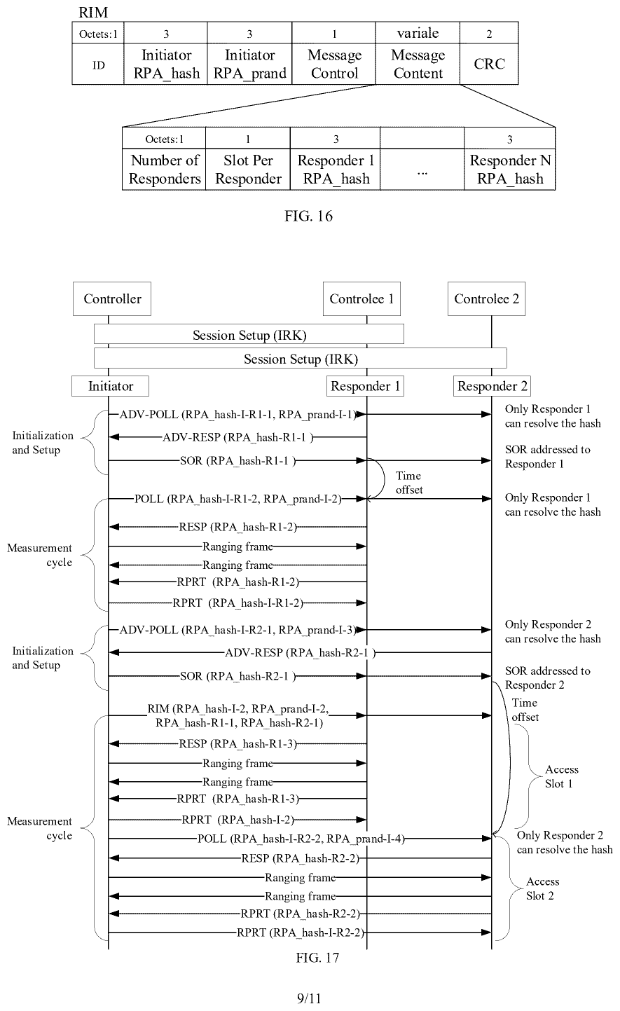

A schematic diagram of a RIM frame is illustrated in FIG. 16. Aside from providing time and frequency synchronization to the responders, another important purpose of the RIM frame is to provide the schedule of the access slots for the MMS ranging to the responders. As shown in FIG. 16, the MessageControl field of the RIM frame carries a list of the responders that are scheduled to participate in the MMS ranging. The Responder RPA_hash used in the ADV-RESP frame from responder n, for example, RPA_hash-Rn-1 (n=1, 2, etc.) is used as the responders' private address and the sequence in which the Responder RPA_hash appears in the MessageContent field of the RIM frame decides the sequence of the responders' access slots for the MMS ranging. Besides, the RIM frame may also carry the initiator's second pseudo random number, RPA_prand-I-2 in the Initiator RPA_prand field, and its private address, the RPA_hash-I-2 in the Initiator RPA_hash field, allowing the responders to verify the initiator's identity.

For example, Responder 1 is scheduled to the first access slot (access slot 0) and Responder 2 is scheduled to the second access slot (access slot 1). Then operations S350 to S380 and S350′ to S380′ will be performed.

S350: Responder 1 transmits a RESP carrying its private address, RPA_hash-R1-2 to the initiator.

Upon receiving the RIM frame, each responder receiving the RIM frame generates a local hash of the Initiator RPA_prand (e.g., RPA_prand-I-2) based on the IRK and if the local hash matches the RPA_hash-I-2 carried in the Initiator RPA_hash field of the RIM frame, the responder will have verified the identity of the initiator.

A responder that receives the RIM frame successfully and that is scheduled to the first access slot (access slot 0), generates its own private address as described above but using the RPA_prand-I-2 carried in the RIM frame and transmits a RESP frame carrying the private address back to the initiator. As mentioned above, the responder may be Responder 1.

It should be noted that the RIM and RESP frames allow the initiator and responder to achieve time and frequency synchronization. An initiator may also include other control information in the RIM frame for the responder.

When the identity verification of the Responder 1 based on RESP is successful, the initiator initiates the ranging phase in which the initiator and responder exchange zero or more RSF and optionally one or more RIF.

After the initiator or the responder, completes the reception of all UWB fragments for the ranging phase, the initiator and/or the responder generate a ranging measurement report, and send the RPRT frame that carries the measurement report to the peer device, each carrying the appropriate private address, as illustrated in operation S370 and S380.

Subsequently, as illustrated in operation S340′, the initiator transmits a POLL frame to Responder 2 at the beginning of the first ranging slot of the second access slot (access slot 1).

The remaining operations in FIG. 13 are similar to the foregoing operations and the foregoing embodiments. Details are not described herein again.

In some embodiments, the format of the ADV-RESP (or RESP) frame in FIG. 13 may be as shown in one of FIG. 5 to FIG. 7, and the specific format of the ADV-RESP (or RESP) frame can be determined by the parameters that are used to generate the ADV-RESP (or RESP) frame. For example, the format of the ADV-RESP (or RESP) frame in FIG. 13 may be as shown in FIG. 5 or FIG. 6 if the private address carried in an ADV-RESP (or RESP) frame is generated by using any one of Equations 2 to 5. Alternatively, the format of the ADV-RESP (or RESP) frame in FIG. 13 may be as shown in FIG. 7 if the private address carried in an ADV-RESP (or RESP) frame is generated by using Equation 6.

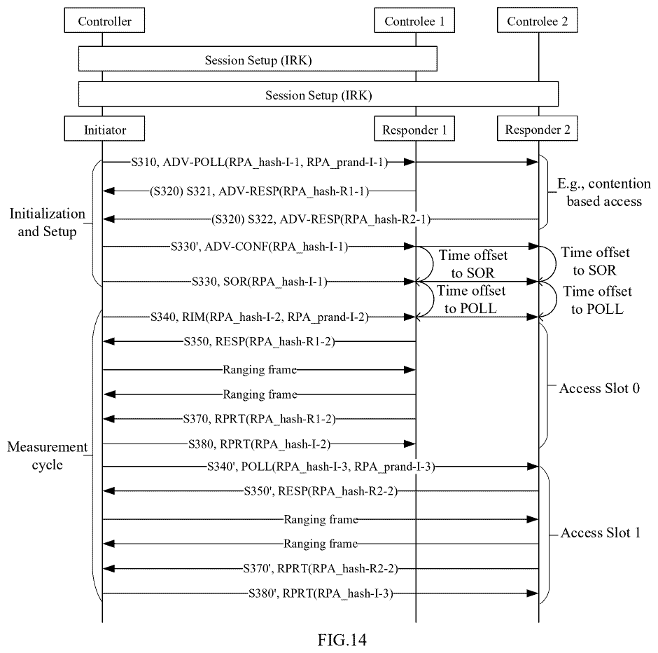

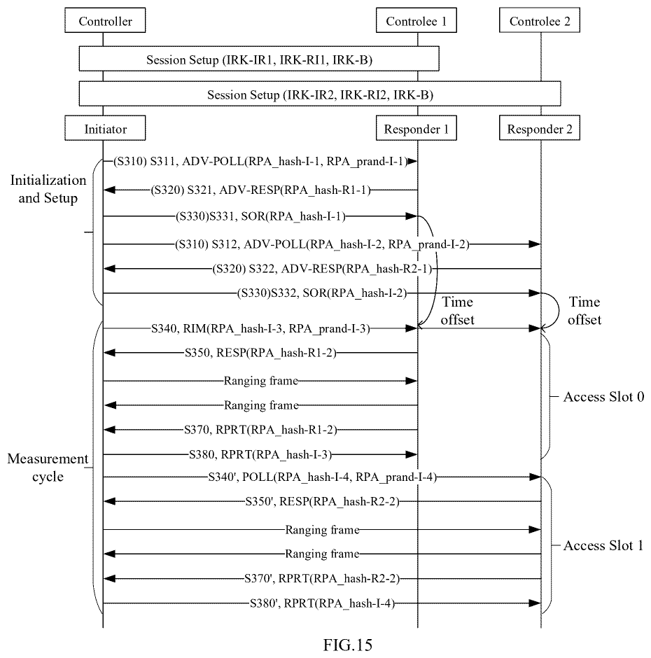

The one-to-many MMS ranging session shown in FIG. 14 is similar to that in FIG. 13. The difference is that UWB channel coordination may be active and prior to transmitting the SOR frame, the initiator scans the initialization channels in NB and the default UWB channels for acquisition packets (APs) from other initiators. In order to perform the acquisition scan, upon receiving the ADV-RESP frame from the responder, instead of immediately transmitting a SOR frame, the initiator transmits to responders an ADV-CONF frame that carries a time offset indicating the transmission time of the SOR, as shown in operation S330′ in FIG. 14 and the initiator performs the acquisition scan for the APs. Based on the information gathered from the APs, the initiator can adapt the configuration parameters for the MMS ranging in the SOR frame.

In some embodiments, the format of the ADV-RESP (or RESP) frame in FIG. 14 may be as shown in FIG. 5 to FIG. 7, and the specific format of the ADV-RESP (or RESP) frame can be determined by the parameters that are used to generate the ADV-RESP (or RESP) frame. For example, the format of the ADV-RESP (or RESP) frame in FIG. 14 may be as shown in FIG. 5 or FIG. 6 if the private address carried in an ADV-RESP (or RESP) frame is generated by using any one of Equations 2 to 5. Alternatively, the format of the ADV-RESP (or RESP) frame in FIG. 14 may be as shown in FIG. 7 if the private address carried in an ADV-RESP (or RESP) frame is generated by using Equation 6.

The one-to-many MMS ranging session shown in FIG. 15 is also similar to that in FIG. 13. The difference is that the responders generate their own private addresses based on the pairwise IRK. In some of the aforementioned embodiments, it was assumed that the IRK exchanged between the initiator and all responders was common to all the responders, i.e., only a single IRK was maintained in the network for the purpose of identifying resolution. However, it is also possible that a common IRK (IRK-B) is shared between all initiators and responders in the same network only for the broadcast frame (e.g., RIM) and a pairwise IRK (IRK-IRn & IRK-RIn, n=responder index) is exchanged between the initiator and each responder for unicast frames in each direction (i.e., one IRK (IRK-IRn, n=responder index) for initiator to responder frames and one IRK (IRK-RIn, n=responder index) for responder to initiator frames). The IRKs are used in subsequent frames as indirect means of identifying the transmitters of frames.

For example, for unicast frames (i.e., frames meant for a single responder, e.g., ADV-POLL frame, POLL frame, REPORT frame) to be transmitted to Responder n, the initiator generates a unique pseudo random number for the responder (RPA_prand-I-n) and uses the initiator's pairwise IRK for the responder (IRK-IRn, n=responder index) to generate the Initiator RPA_hash (RPA_hash-I-n) by using Equation 1 and includes RPA_hash-I-n and RPA_prand-I-n in the initial unicast frames for Responder n. When Responder n receives the initial unicast frame transmitted by the initiator's ADV-POLL (or POLL) frame, the Responder n generates a local hash of the Initiator RPA_prand carried in the ADV-POLL (or POLL) frame and the IRK-IRn as inputs to Equation 1. If the local hash matches the Initiator RPA_hash carried in the ADV-POLL (or POLL) frame, the responder will have verified the identity of the initiator.

Similarly, for broadcast frames (i.e., frames meant for multiple responders, e.g., POLL for one-to-many ranging, i.e., RIM frame), the initiator generates a unique pseudo random number (RPA_prand-B-I) and uses the common broadcast IRK (IRK-B) to generate the Initiator RPA_hash (RPA_hash-B-I) by using Equation 1 and includes RPA_hash-B-I and RPA_prand-B-I) in the broadcast frame. When a responder receives the initial broadcast frame (e.g., RIM frame) transmitted by the initiator, the responder generates a local hash of the Initiator RPA_prand carried in the frame and the IRK-B as inputs to Equation 1. If the local hash matches the Initiator RPA_hash carried in the frame, the responder will have verified the identity of the initiator.

Similarly, in its response frames, the Responder n includes its RPA_hash generated by using Equation 5 as the only address field in its frames (e.g., ADV-RESP or RESP); responder uses its unique pairwise IRK (IRK-RIn) and Initiator RPA_prand (e.g., RPA_prand-I-n) in the preceding initial frame to generate it's RPA_hash (RPA_hash-R-n). For example, Responder 1 generates its own private address based on IRK-RI1 and Responder 2 generates its own private address based on IRK-RI2 using Equation 5. Correspondingly, the initiator verifies the identity of Responder 1 based on IRK-RI1 and the identity of Responder 2 based on IRK-RI2. Based on the IRK used, the initiator is able to implicitly identify the responder (for example, by mapping the IRK to the initiator's record of the responder's public address). Another difference is that since pairwise IRK is used to generate the private address (e.g., Initiator RPA_hash) in the ADV-POLL and POLL frames, only the target responder (the responder that possess the correct IRK) is able to correctly verify the private address and hence only the targeted responder will respond to the ADV-POLL or POLL frame, with the ADV-RESP or RESP frame respectively. Correspondingly, the SOR frames are also targeted at one responder at a time. This allows the initiator to selectively choose the responder(s) to participate in the MMS ranging.

For example, the format of the ADV-RESP (or RESP) frame in FIG. 15 may be as shown in FIG. 5 to FIG. 7, and the specific format of the ADV-RESP (or RESP) frame can be determined by the parameters that are used to generate the ADV-RESP (or RESP) frame. For example, the format of the ADV-RESP (or RESP) frame in FIG. 15 may be as shown in FIG. 5 or FIG. 6 if the private address carried in an ADV-RESP (or RESP) frame is generated by using any one of Equations 2 to 5. Alternatively, the format of the ADV-RESP (or RESP) frame in FIG. 15 may be as shown in FIG. 7 if the private address carried in an ADV-RESP (or RESP) frame is generated by using Equation 6.

In the above examples using a common IRK as shown in FIG. 3, and FIG. 12 to FIG. 14, the initiator's ADV-POLL and POLL frames were not directed at any particular responder and any responder that possessed the common IRK can verify the initiator's private address and respond to the ADV-POLL and POLL frames. However, at times it is possible that the initiator may want to select a particular responder to participate in the MMS ranging. Such an example is shown in FIG. 17. The initiator can achieve this by including the target responder's identity (e.g., the 8-octets extended 802.15 MAC address) and the ID of the compressed PSDU (e.g., ADV-POLL) in the computation of the Initiator RPA_hash for responder n (e.g., RPA_hash I-Rn, n=1, 2, . . . ) and truncated to 24 bits by using Equation 7:

$$Equation 7$$

$$RPA\_hash = AES - 128 - ECB ( key = IRK , data = ( 0 x 000 … [ 4 ] ‖ ID ‖ , 8 - octets extended 802.15 MAC address of responder n [ 8 ] ‖ RPA\_prand - I ] ) \% 2 \hat{} 24$$

For example, in a first ADV-POLL, the initiator includes Responder 1's extended 802.15 MAC address in the computation of the Initiator RPA_hash (RPA_hash-I-R1-1) included in the ADV-POLL frame. Even though both Responder 1 and Responder 2 receive the ADV-POLL frame, only Responder 1 is able to verify the initiator's private address (RPA_hash-I-RI-1) and thereby, only Responder 1 responds with the ADV-RESP frame.

Similarly, the Responder n can also use the same Equation 7 to generate its private address (RPA_hash-Rn) to be used in the ADV-RESP and RESP frames. Although the same equation is used, the inclusion of the ID field (e.g., ADV-RESP) ensures that the private addresses generated by the initiator and the responders are different and the initiator can verify that the responder is in possession of a valid IRK. For example, the Responder 1 generates its private address using Equation 7 and transmits the ADV-RESP frame to the initiator, which then responds with a SOR frame to invite Responder 1 to participate in the one-to-one MMS ranging. Subsequently the initiator transmits another ADV-POLL targeted at Responder 2 and if it receives an ADV-RESP from the Responder 2, invites Responder 2 to joint Responder 1 for a one-to-many MMS ranging by transmitting a SOR frame to it. Here it is assumed that Responder 1 continues the MMS ranging session in the subsequent round/block. The RIM frame from the initiator assigns Responder 1 and Responder 2 to the first and second access slots of the one-to-many MMS ranging respectively by including their private addresses in the RIM frame as described earlier in FIG. 16.

It should be noted that the RPRT frame in foregoing embodiments may also carry an initiator's private address and a responder's private address.

It should be also noted that, for the method of generating the responder's private address, for the method of verifying the responder's identity, and for other related content in one-to-many MMS ranging session, reference is made to the foregoing embodiments. Details are not described herein again.

The present application provides a communication method allowing the initiator to determine whether the response frame is truly from the authorized responder. Especially, in one-to-many MMS ranging, the communication method enables the initiator to identify different responders without revealing the identities of responders. In addition, security of the compressed frame is taken into account.

Combined with the foregoing method embodiment, the present application further provides related devices, and the devices may be located in a controller or a controlee. The related devices may perform the operations of the foregoing method embodiment.

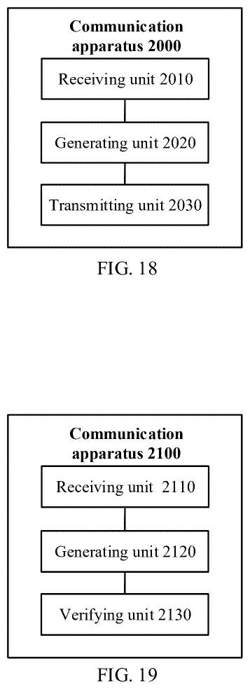

FIG. 18 is a schematic block diagram of a communication apparatus 2000 according to an embodiment of this application. The communication apparatus 2000 can perform the operations executed by the responder in foregoing embodiments. As shown in FIG. 18, the communication apparatus 2000 includes: a receiving unit 2010, configured to receive from an initiator, a first frame for initiating a ranging process; a generating unit 2020, configured to generate a first private address based on the first frame and information related to an identity of the first responder, and the information related to the identity of the first responder is known to the initiator; and a transmitting unit 2030, configured to transmit a second frame carrying the first private address to the initiator.

In an embodiment, the information related to the identity of the first responder includes any one of: a public address of the first responder, MMS ranging configuration requested by the first responder, a first random number generated by the first responder, or an IRK unique to the initiator and the first responder.

In an embodiment, the first frame carries a second random number, and the second random number is associated with a second private address of the initiator; and the generating unit 2020 is configured to: generate the first private address based on the second random number and the information related to the identity of the first responder.

In an embodiment, the second private address is generated based on information related to an identity of a second responder, the generating unit 2020 is configured to: generate the first private address when it is determined that the second responder and the first responder are the same responder.

In an embodiment, the transmitting unit 2030 is configured to: transmit the second frame carrying the first private address and the first random number to the initiator.

In an embodiment, the first frame is a RIM frame carrying a list associated with responders that are scheduled to participate in an MMS ranging, and the responders include the first responder; and the generating unit 2020 is configured to: generate the first private address when it is determined that the first responder is scheduled to the first access slot among multiple access slots based on the list.

In an embodiment, the second frame includes any one of: an ADV-RESP frame, a RESP frame, or a RPRT frame.

In an embodiment, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

In an embodiment, the first Nonce includes frame counter information, and the frame counter information indicates the time period for the transmission of the secured frame.

In an embodiment, the first Nonce further includes block structure indication information, and the block structure indication information indicates whether the second frame is transmitted inside or outside a block structure.

In an embodiment, the second frame further carries a private address of the initiator.

In an embodiment, the receiving unit 2010 is further configured to: receive a third frame carrying time-offset information from the initiator, and the time-offset information indicates a time offset of a SOR frame transmitted.

FIG. 19 is a schematic block diagram of a communication apparatus 2100 according to an embodiment of this application. The communication apparatus 2100 can perform the operations executed by the initiator in foregoing embodiments. As shown in FIG. 19, the communication apparatus 2100 includes: a receiving unit 2110, configured to receive a second frame carrying a first private address from a first responder, and the first private address is associated with information related to an identity of the first responder; a generating unit 2120, configured to generate a third private address based on the information related to the identity of the first responder; and a verifying unit 2130, configured to verify the identity of the first responder by comparing the third private address with the first private address.

In an embodiment, the information related to the identity of the first responder includes any one of: a public address of the first responder, MMS ranging configuration requested by the first responder, a first random number generated by the first responder, or an IRK unique to the initiator and the first responder.

In an embodiment, the communication apparatus further includes a transmitting unit configured to: transmit a first frame for initiating a ranging process, and the first frame carries a second random number, and the second random number is associated with a second private address of the initiator; and the generating unit 2120 is configured to: generate the third private address based on the second random number and the information related to the identity of the first responder.

In an embodiment, the generating unit 2120 is further configured to: generate a fourth private address based on information related to an identity of a second responder; and the transmitting unit is further configured to: transmit a frame carrying the fourth private address to the second responder.

In an embodiment, the second frame further carries the first random number, the generating unit 2120 is configured to: generate the third private address based on the first random number.

In an embodiment, the transmitting unit is further configured to: transmit a first frame for initiating a ranging process to the first responder, and the first frame is a RIM frame carrying a list associated with responders that are scheduled to participate in MMS ranging, and the responders include the first responder.

In an embodiment, the second frame includes any one of: an ADV-RESP frame, a RESP frame, or a RPRT frame.

In an embodiment, the first frame or the second frame is a secured frame carrying encrypted information, and the encrypted information is obtained based on a first Nonce; and the first Nonce is associated with any one of: a private address carried by the secured frame, a random number used to generate the private address, or a time period for transmission of the secured frame.

In an embodiment, the first Nonce includes frame counter information, and the frame counter information indicates the time period for the transmission of the secured frame.

In an embodiment, the first Nonce further includes block structure indication information, and the block structure indication information indicates whether the second frame is transmitted inside or outside a block structure.

In an embodiment, the second frame further carries a private address of the initiator; the verifying unit 2130 is further configured to: verify the identity of the first responder based on the private address of the initiator.

In an embodiment, the transmitting unit is further configured to: transmit a third frame carrying time-offset information to the first responder, and the time-offset information indicates a time offset of a SOR frame transmitted.

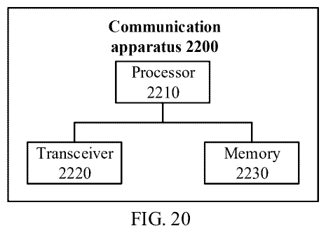

As shown in FIG. 20, a communication apparatus 2200 may include a processor 2210, a transceiver 2220, and a memory 2230. The transceiver 2220 may be configured to receive a query. The memory 2230 may be configured to store code, instructions, and the like executed by the processor 2210.

Besides, the memory 2230 may be further configured to store data corresponding to generating and/or verifying private addresses, such as IRKs pre-negotiated between the initiator and the responder.

The memory 2230 may include a random memory, a flash memory, a read-only memory, a programmable read-only memory, a non-volatile memory, a register, or the like. The processor 2210 may be a central processing unit (CPU).

For other functions and operations of the communication apparatus 2200, refer to processes of the method embodiments in FIG. 2, FIG. 3, FIG. 12 to FIG. 15, and FIG. 17, which are not described again herein to avoid repetition.

An embodiment of the present application further provides a communication system. The communication system includes communication apparatus 2000 and communication apparatus 2100, or the communication system includes communication apparatus 2200.

An embodiment of the present application further provides a computer storage medium, and the computer storage medium may store a program instruction for performing the operations in the foregoing methods.

Optionally, the storage medium may be specifically the memory 2230.

An embodiment of the present application further provides a computer program product. The computer program product includes computer program code. When the computer program code runs on a computer, the computer is enabled to perform the operations in the foregoing methods.

Optionally, all or a part of computer program code can be stored in on a first storage medium. The first storage medium can be packaged together with the processor or separately with the processor.

An embodiment of the present application further provides a chip system, where the chip system includes an input/output interface, at least one processor, at least one memory, and a bus. The at least one memory is configured to store instructions, and the at least one processor is configured to invoke the instructions of the at least one memory to perform operations in the methods in the foregoing embodiments.

In the embodiments of the present application, “at least one” means one or more, and “a plurality of” means two or more. The term “and/or” describes an association relationship between associated objects and represents that three relationships may exist. For example, A and/or B may represent the following three cases: only A exists, both A and B exist, and only B exists, where A and B may be singular or plural. The character “/” generally indicates an “or” relationship between the associated objects. “At least one of the following” and a similar expression thereof refer to any combination of these items, including any combination of one item or a plurality of items. For example, at least one of a, b, and c may indicate: a, b, c, a and b, a and c, b and c, or a, b, and c, where a, b, and c may be singular or plural.

A person of ordinary skill in the art may understand that all or some of the processes of the methods in the embodiments may be implemented by a computer program instructing related hardware. The program may be stored in a computer-readable storage medium. When the program runs, the processes of the methods in the embodiments are performed. The foregoing storage medium may include: a magnetic disk, an optical disc, a read-only memory (ROM), or a random-access memory (RAM).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

The foregoing are merely exemplary embodiments of the present invention. A person skilled in the art may make various modifications and variations to the present invention without departing from and scope of the present invention.

What is claimed is:

1. A communication method of a first responder, comprising:
receiving, from an initiator, a first frame for initiating a ranging process;
generating a first private address based on the first frame and information related to an identity of the first responder; and
transmitting a second frame carrying the first private address to the initiator.

2. The communication method according to claim 1, wherein the information related to the identity of the first responder comprises any one of: a public address of the first responder, multi-millisecond (MMS) ranging configuration requested by the first responder, a first random number generated by the first responder, or an identity resolving key (IRK) unique to the initiator and the first responder.

3. The communication method according to claim 2, wherein the first frame carries a second random number, and the second random number is associated with a second private address of the initiator; and
the generating the first private address based on the first frame and information related to the identity of the first responder comprises:
generating the first private address based on the second random number and the information related to the identity of the first responder.

4. The communication method according to claim 3, wherein the second private address is generated based on information related to an identity of a second responder, the generating a first private address based on the first frame and the information related to an identity of the first responder comprises:
generating the first private address when it is determined that the second responder and the first responder are a same responder.

5. The communication method according to claim 2, wherein the transmitting the second frame carrying the first private address to the initiator comprises:
transmitting the second frame carrying the first private address and the first random number to the initiator.

6. The communication method according to claim 2, wherein the IRK is a common IRK between the initiator and the first responder, or the IRK is one IRK of a pairwise IRK unique to the initiator and the first responder.

7. The communication method according to claim 1, wherein the first frame is a ranging initialization message (RIM) frame carrying a list associated with responders that are scheduled to participate in an MMS ranging, wherein the responders comprise the first responder; and
the generating the first private address by using information related to the identity of the first responder comprises:
generating the first private address when it is determined that the first responder is scheduled to a first access slot among multiple access slots based on the list.

8. The communication method according to claim 1, wherein the second frame comprises any one of: an advertising response (ADV-RESP) frame, a response (RESP) frame, or a report (RPRT) frame.

9. A communication apparatus, comprising:
a receiver configured to receive, by a first responder from an initiator, a first frame for initiating a ranging process;
a processor configured to generate a first private address based on the first frame and information related to an identity of the first responder; and
a transmitter, configured to transmit a second frame carrying the first private address to the initiator.

10. The communication apparatus according to claim 9, wherein the information related to the identity of the first responder comprises any one of: a public address of the first responder, multi-millisecond (MMS) ranging configuration requested by the first responder, a first random number generated by the first responder, or an identity resolving key (IRK) unique to the initiator and the first responder.

11. The communication apparatus according to claim 10, wherein the first frame carries a second random number, and the second random number is associated with a second private address of the initiator; and the processor is configured to:
generate the first private address based on the second random number and the information related to the identity of the first responder.

12. The communication apparatus according to claim 11, wherein the second private address is generated based on information related to an identity of a second responder, and the processor is configured to:
generate the first private address when it is determined that the second responder and the first responder are a same responder.

13. The communication apparatus according to claim 10, wherein the transmitter is configured to:
transmit the second frame carrying the first private address and the first random number to the initiator.

14. The communication apparatus according to claim 10, wherein the IRK is a common IRK between the initiator and the responder, or the IRK is one IRK of a pairwise IRK unique to the initiator and the responder.

15. A non-transitory computer-readable storage medium of a first responder that stores instructions, and when the instructions are run on a processor, the processor causes a communication apparatus to:
receive, from an initiator, a first frame for initiating a ranging process;
generate a first private address based on the first frame and information related to an identity of the first responder; and
transmit a second frame carrying the first private address to the initiator.

16. The non-transitory computer-readable storage medium according to claim 15, wherein the information related to the identity of the first responder comprises any one of: a public address of the first responder, multi-millisecond (MMS) ranging configuration requested by the first responder, a first random number generated by the first responder, or an identity resolving key (IRK) unique to the initiator and the first responder.

17. The non-transitory computer-readable storage medium according to claim 16, wherein the first frame carries a second random number, and the second random number is associated with a second private address of the initiator; and
the communication apparatus to generate a first private address based on the first frame and information related to an identity of the first responder further comprises the communication apparatus to:
generate the first private address based on the second random number and the information related to the identity of the first responder.

18. The non-transitory computer-readable storage medium according to claim 17, wherein the second private address is generated based on information related to an identity of a second responder, and the generation of the first private address based on the first frame and information related to the identity of the first responder further comprises the communication apparatus to:
generate the first private address when it is determined that the second responder and the first responder are the same responder.

19. The non-transitory computer-readable storage medium according to claim 16, wherein the transmission of the second frame carrying the first private address to the initiator further comprises the communication apparatus to:
transmit the second frame carrying the first private address and the first random number to the initiator.

20. The non-transitory computer-readable storage medium according to claim 16, wherein the IRK is a common IRK between the initiator and the responder, or the IRK is one IRK of a pairwise IRK unique to the initiator and the responder.
